(19) United States
(12) Patent Application Publication
(10) Pub. No.: US 2012/0018689 A1
(43) Pub. Date: Jan. 26, 2012

(54) Patient Lift Device

(75) Inventors: Mark P. Chepurny, Bradford (CA); Vahideh Hashemi, Richmond Hill (CA)

(73) Assignee: PRISM MEDICAL LTD., Vaughan (CA)

(21) Appl. No.: 13/144,528

(22) PCT Filed: Jan. 8, 2010
(86) PCT No.: PCT/CA2010/000022

§ 371 Date: Oct. 4, 2011

(30) Foreign Application Priority Data
Jan. 15, 2009 (CA) 2649950

(51) Int. Cl. A61G 7/10

(52) U.S. Cl. 254/342

(57) ABSTRACT

A patient lift device comprising: a patient carrier for carrying to a patient to be lifted; a support element sized, shaped and positioned to couple the patient lift device to an upper support; an unmotorized lifting mechanism, operatively connected to the patient carrier and support element so as to raise or lower the patient carrier when the unmotorized lifting mechanism is actuated; and a power tool coupling, operatively connected to the unmotorized lifting mechanism such that when a power tool is coupled to the power tool coupling and actuated, the unmotorized lifting mechanism is actuated, the power tool coupling being configured to detachably mate with a driven power tool head.

### FIELD OF THE INVENTION

This invention relates to the field of care for and treatment of disabled patients, primarily those unable to stand or walk on their own. More particularly, this invention relates to lift devices for use in the care for and treatment of disabled patients.

### BACKGROUND OF THE INVENTION

There are a wide variety of known patient lift devices. There are two broad categories of patient lifts: fixed and portable. A fixed lift is more or less permanently mounted on a track that is, typically, fixed to a ceiling. A strap for lifting and lowering a patient extends from the lift and carries a patient harness. The lift can extend or retract the strap to lower or lift the patient. The lift is also movable along the track. Typically, both the lift/lower function and the movement along the track are motorized, that is, powered by an electric (or other) motor.

Portable lifts may be used either with fixed track, or with portable support frames that provide overhead tracks. In either case, the portable lift is detachably attachable to the track. By extending and retracting a strap, it can move the patient up and down. The lift is movable along the track. While the movement along the track may or may not be motorized, the lift/lower function is typically motorized.

There are significant problems associated with motorized lifting and lowering. First, there is a substantial cost associated with including a motor, and associated control circuitry, in a lift. This additional cost must be passed on to the buyer of the lift, sometimes a disabled adult with limited resources.

Second, motors and their associated control circuitry can and do fail periodically. The result is downtime for the lift, adversely affecting the disabled patient.

Third, when motorized lifts are used, they must be powered. The typical way to power a motorized lift is via batteries that are recharged periodically. There are some challenges that this situation presents. If the user forgets to recharge the batteries, the lift may run out of power when it is needed. Alternatively, the lift may require such long and frequent use that there is insufficient time to recharge the batteries. In addition, it is necessary to locate a convenient place and power source for recharging the batteries, which may be difficult.

### SUMMARY OF THE INVENTION

Therefore, what is preferred is a patient lift device that provides at least one of the advantages of motorized lifting and lowering, while also avoiding or mitigating at least one of the disadvantages of motorized lifting and lowering.

According to one aspect of the invention, there is provided a patient lift device comprising:
a patient carrier for carrying a patient to be lifted;
a support element sized, shaped and positioned to couple the patient lift device to an upper support;
an unmotorized lifting mechanism, operatively connected to the patient carrier and support element so as to raise or lower the patient carrier when the unmotorized lifting mechanism is actuated;
a power tool coupling, operatively connected to the unmotorized lifting mechanism such that when a power tool is coupled to the power tool coupling and actuated, the unmotorized lifting mechanism is actuated, the power tool coupling being configured to detachably mate with a driven power tool head.

Optionally, the patient lift device further comprises a manual actuator configured and positioned to actuate the unmotorized lifting mechanism. Optionally, the manual actuator comprises a chain. Optionally, the unmotorized lifting mechanism includes a sprocket having teeth configured to be gripped by the chain. Optionally, the chain comprises a plurality of joined links, each link including a hole sized, shaped and positioned to grip said teeth. Optionally, each said link comprises a shaft and a recess, the shaft of each link being sized, shaped and positioned to snap fit into a recess of an adjacent link to form a chain. Optionally, said links are substantially identical to one another in shape. Optionally, said patient carrier comprises a pair of hooks, said hooks being sized, shaped and positioned to hold a patient harness. Optionally, each hook includes a movable arm having an open position for admitting the patient harness and a closed position for holding the patient harness on the hook. Optionally, the movable arm is biased to the closed position. Optionally, the support element comprises a strap connected to the unmotorized lifting mechanism, and an attachment element sized, shaped and positioned to connect the strap to the upper support. Optionally, the unmotorized lifting mechanism comprises a spool for winding and unwinding said strap, and a mechanism for moving said spool so as to wind and unwind said strap. Optionally, said mechanism for moving said spool comprises a plurality of gears. Optionally, said power tool coupling comprises a female coupling configured to detachably mate with a male driven power tool head. Optionally, the power tool coupling comprises a recess for receiving a Robertson screwdriver head. Optionally, the power tool coupling comprises a hexagonal recess. Optionally, the coupling comprises a substantially cube-shaped recess.

In another aspect of the invention, there is provided a method of lifting a patient that is attached to a patient lift device, the patient lift device including an unmotorized lifting mechanism, the method comprising the steps of:

mating the driven power tool head of a power tool with a power tool coupling on the patient lift device;

actuating the power tool to drive the power tool head so as to actuate the power tool coupling and the unmotorized lifting mechanism;

detaching the driven power tool head from the power tool coupling.

Optionally, the power tool comprises a power drill. Optionally, the power tool comprises a powered screw driver. Optionally, the power tool comprises a powered ratchet.

### BRIEF DESCRIPTION OF THE DRAWINGS

Reference will now be made, by way of example only, to preferred embodiments of the present invention as depicted in the following drawings:

FIG. 1 is a front perspective view of a preferred embodiment of the patient lift device;

FIG. 2 a perspective view of two links of a chain according to an embodiment of the present invention;

FIG. 3 is a front perspective view of a preferred embodiment of the patient lift device without its housing;

FIG. 4 is a rear perspective view of a preferred embodiment of the patient lift device, showing detail inside the framework/gearbox;

FIG. 5 is a front perspective view of a patient lift device with a power tool detachably mated to the power tool coupling; and

FIG. 6 is an exploded view of the brake associated with a preferred embodiment of the lift device.

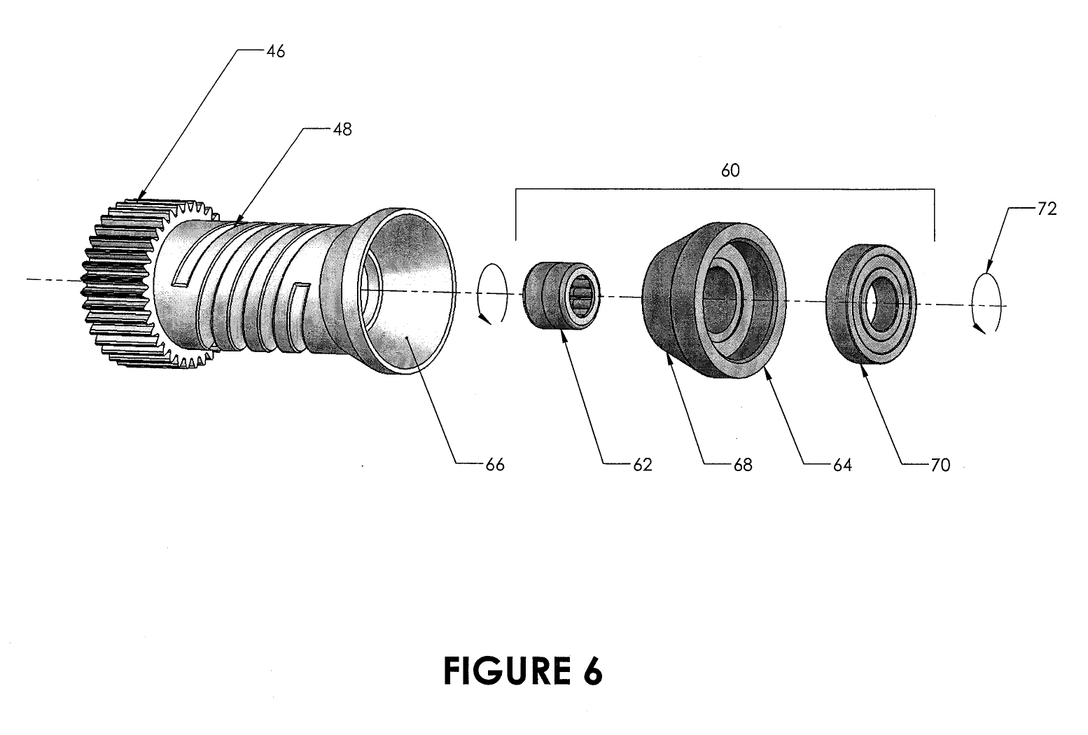

### DETAILED DESCRIPTION OF THE PREFERRED EMBODIMENTS

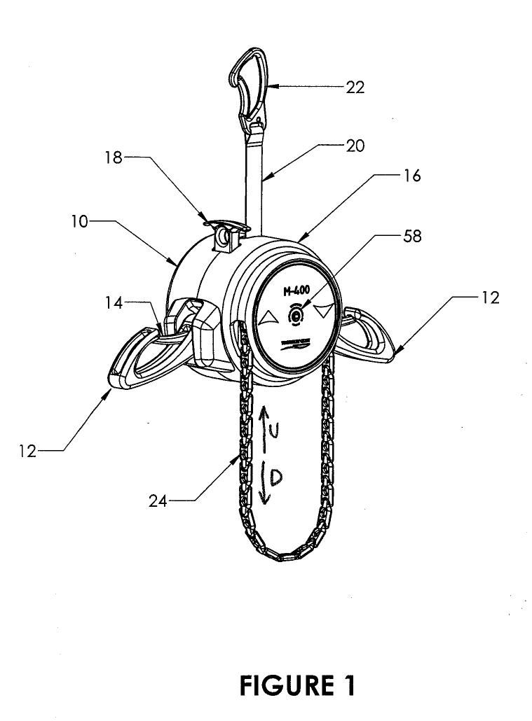

Referring now to FIG. 1, a patient lift device 10 according to the present invention is shown. Lift 10 includes a patient carrier for carrying a patient to be lifted. In the preferred embodiment shown in FIG. 1, the patient carrier comprises a pair of extended closeable hook members 12. Each of the hook members 12 is configured to receive a patient harness (not shown). To be lifted and lowered, a patient is placed in the harness that is held by hook members 12. Hook members 12 each include a displaceable arm 14 which can be opened to admit a strap or other portion of a patient harness. Once the harness is admitted into the hook member 12, the arm 14 is closed to hold the harness in place. The preferred arm 14 is biased to a closed position, and can be opened by manual application of force.

The lift 10 further includes a housing 16 which houses a lifting mechanism (described below). Extending outward from the top of the housing 16 is a handle 18 for carrying lift 10 when it is not in use. It will be appreciated that the lift shown in FIG. 1 is a portable lift. It can be detached from an overhead track or the like in association with which it is used, carried to another location, attached to another overhead track or the like, and used there. Handle 18 is preferably configured to fold down and rest flush with the surface of housing 16 when not in use.

Also extending outward from the housing 16 is a support element for coupling the patient lift device to an upper support. In the preferred embodiment, this support element takes the form of strap 20 carrying on its end carabiner 22. Carabiner 22 is configured to be detachably attached to an upper support (not shown), such as a wheeled trolley (not shown) attached to an overhead track (not shown) along which the lift 10 can be horizontally moved. In such a configuration, the lift 10 can be moved laterally by pulling lift 10 and strap 20, thus causing the wheeled trolley and lift 10 to move along the overhead track.

The lift 10 further comprises a manual lifting mechanism actuator, which most preferably takes the form of chain 24. Chain 24 is operatively connected to the unmotorized lifting mechanism (described below). The chain 24 is preferably formed in a closed loop, and connected to a sprocket or gear within housing 16. In the embodiment shown, when the chain is pulled in direction U, the patient is lifted, and when the chain is pulled in direction D, the patient is lowered.

It will be appreciated by those skilled in the art that the manual lifting mechanism actuator may take other forms and still be comprehended by the invention. For example, it may take the form of a crank operatively connected to the unmotorized lifting mechanism. What is important is that the actuator function to manually actuate unmotorized lifting mechanism.

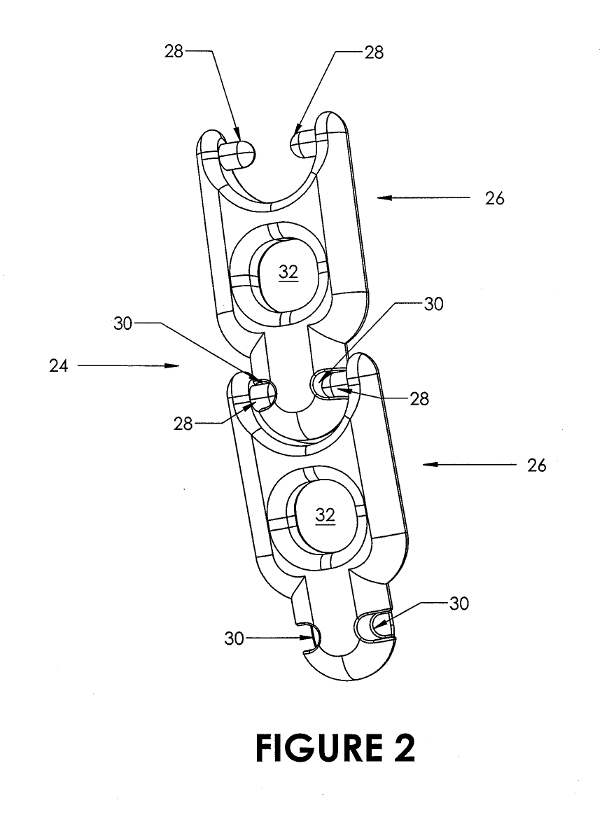

The chain 24 is preferably comprised of a plurality of identical links 26, shown in FIG. 2. Each link 26 comprises two shafts 28 at one end and corresponding hollows 30 at the other. The shafts 28 snap into the hollows 30 of the link adjacent to it, and the hollows 30 receive by a snap fit the shaft 28 of the link adjacent to it.

Each link also preferably includes a gear gripping element to allow each link 26 in the chain 24 to grip the gear or sprocket associated with the unmotorized lifting mechanism described below. In the preferred embodiment shown in FIG. 1, the gear gripping element comprises a hole 32 in the body of each link 26, the hole being sized and positioned to mate with and grip the teeth or gear elements of the gear or sprocket associated with the unmotorized lifting mechanism.

It will be appreciated that this structure for chain 24 has certain advantages. First, because all links 26 are identical, the chain is cheaper and simpler to manufacture than it would be if more than one type of link were required. Preferably, the links 26 are made of moulded plastic, and can thus be manufactured by moulding a plurality of identical plastic links 26. Second, the chain 24 can be shortened and lengthened quite simply. To shorten chain 24, a user may simply remove a desired number of links by snapping them out of the chain 24, and reclosing the chain 24 by snapping the two free ends together. To lengthen the chain 24, the chain is opened by snapping two links apart, and additional links are inserted by snap fit, and the free ends of the chain are then connected by snap fit. Because all of the links are identical, it is not necessary to open the chain at a particular location, or to insert particular links at particular locations. Rather, since all links are identical, the chain can be opened anywhere along its length, and links added or removed. The result is that the process of lengthening or shortening the chain is more convenient, simpler and faster.

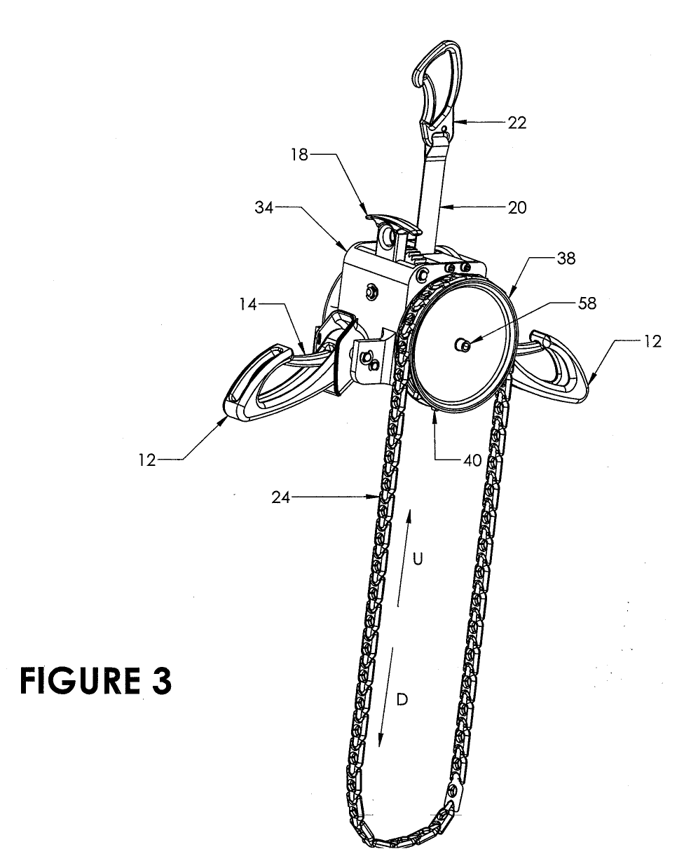

Referring now to FIG. 3, the lift 10 is shown without housing 16. As can be seen in FIG. 3, hooks 12 depend from framework 34. Framework 34 is preferably comprised of a plurality of rigidly connected metal plates that act as the rigid structure of the lift 10. Affixed to framework 34 is the unmotorized lifting mechanism (described below), housing 16 and handle 18. Chain 24 is shown gripping and mating with actuator sprocket 38, which has sprocket teeth 40 that mate with holes 32 in links 26. Actuator sprocket 38 forms part of the unmotorized lifting mechanism further described below. When the chain is moved in direction U, the sprocket 38 is turned to actuate the lifting mechanism so as to raise the patient that is carried by hooks 12. When the chain is moved in direction D, the sprocket 38 is turned to actuate the lifting mechanism so as to lower the patient that is carried by hooks 12.

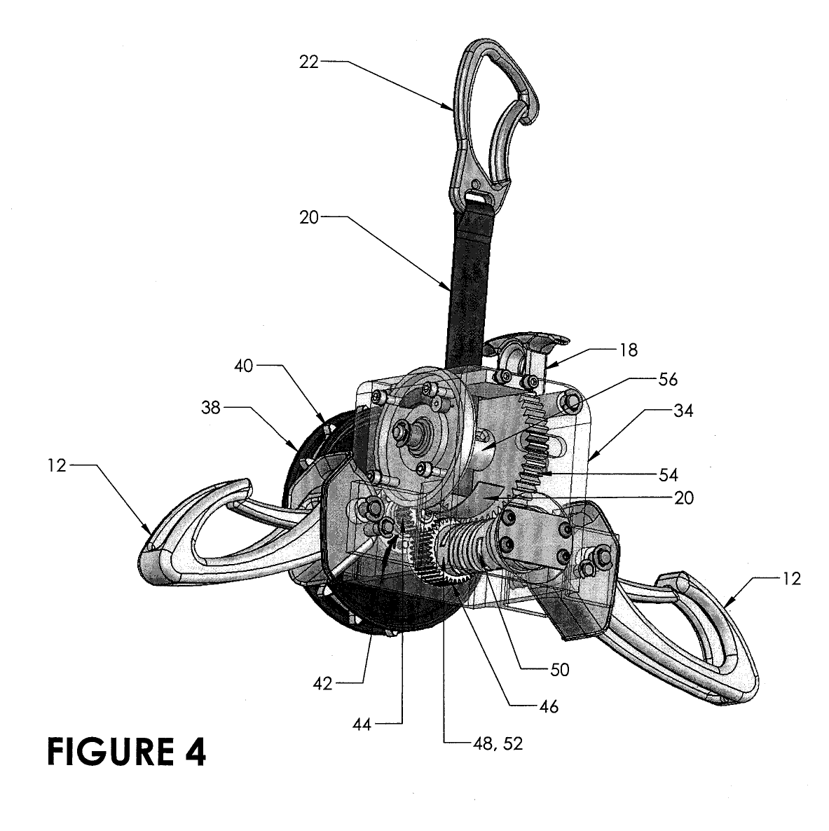

Referring now to FIG. 4, sprocket 38 is operatively connected via sprocket shaft 42 to drive gear 44. Drive gear 44 is operatively engaged with the driven gear portion 46 of worm gear 48. In turn, worm gear 48 is operatively engaged with spool gear 54.

In this embodiment, sprocket 38 is rigidly fixed to shaft 42, which is rigidly fixed to drive gear 44. Thus, when the chain 24 is moved to turn sprocket 38, shaft 42 and drive gear 44 turn in concert with sprocket 38. Meanwhile, the teeth on drive gear 44 are engaged with teeth on driven gear portion 46, so that when drive gear 44 turns, driven gear portion 46 turns. Since driven gear portion 46 is integral to worm gear 48, worm gear 48 is turned when driven gear portion 46 turns. Worm gear 48 includes a helical groove 50 on cylindrical portion 52 of worm gear 48. The teeth of spool gear 54 are engaged with groove 50 so that when worm gear 48 turns, spool gear 54 turns.

Spool gear 54 is attached to spool 56, so that when spool gear 54 turns, spool 56 turns. Strap 20 is attached to and wound around spool 56. Thus, when spool 56 turns, strap 20 is either extended (which in this embodiment would result in the lift 10, and the patient, being raised), or retracted (which in this embodiment would result in the lift 10, and the patient, being lowered).

In this embodiment, sprocket 38, shaft 42, drive gear 44, worm gear 48, spool gear 54 and spool 56 collectively function as an unmotorized lifting mechanism, powered by manual or other unmotorized means, for lifting and lowering the patient. Those skilled in the art will appreciate that an unmotorized lifting mechanism can take other forms besides the specific one described in detail herein. What is important is that the unmotorized lifting mechanism comprise a lifting mechanism, without a motor.

The illustrative embodiment described herein comprises a portable lift which lifts the patient carrier by retracting a strap that extends upward from the lift. However, it will be appreciated that the invention comprehends fixed as well as portable lifts, and also comprehends other methods of lifting and lowering the patient carrier.

The lift 10 further includes power tool coupling 58. Power tool coupling 58 is operatively connected to the unmotorized lifting mechanism such that when a power tool 59 is coupled to the power tool coupling 58 and actuated, the unmotorized lifting mechanism is actuated. The power tool coupling is configured to detachably mate with a driven power tool head 61.

In the preferred embodiment, the power tool coupling 58 is positioned to as to be rigidly connected to the shaft 42. Thus, when a driven power tool head 61 is mated with the coupling 58, and the head is actuated and thus rotated, the sprocket 38 and shaft 42 are rotated, thus actuating the lifting mechanism as described above.

It will be appreciated that the power tool coupling 58 and corresponding power tool head 61 can take a wide variety of forms and still be comprehended by the invention. For example, the coupling 58 can be female (as shown in the figures), and the power tool head 61 male, or vice versa, or neither. What is important is that the power tool coupling be configured to detachably mate with a driven power tool head 61. By “detachably mate”, it is meant that the power tool head 61 is detachably engaged with the coupling 58 so that when the head is driven, the coupling is driven by the head in concert.

The power tool 59, and power tool head 61, may take many forms. For example, the power tool could be an air- or electricity-driven ratchet. In such a case, the head may be a male, substantially cube-shaped, ratchet head, while the coupling 58 would be a female, substantially cube-shaped, recess configured to detachably mate with the head.

Another example of a possible power tool is a power drill or power screw driver. These tools can carry heads (usually removable) which can mate with the coupling 58. For example, such a head could be a Robertson screwdriver head, with the coupling 58 being a correspondingly sized and shaped recess, so that the Robertson screwdriver head can detachably mate with the recess that constitutes coupling 58 in this example.

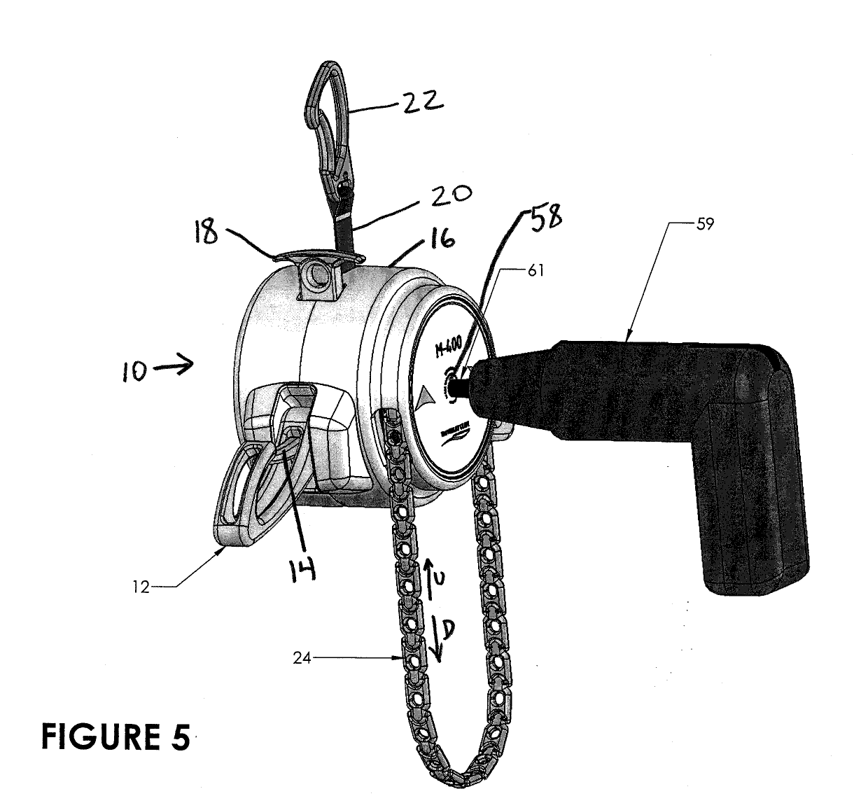

To lift or lower the patient, a user could use the power tool, having a driven power tool head, and actuate the power tool head. Preferably, the power tool would be a rotary tool, though the invention comprehends other types of power tool. The user would detachably mate the power tool head with the coupling 58, and would actuate the power tool, thus driving the power tool head. The motion of the power tool head would cause corresponding motion in the coupling 58, thus actuating the lifting mechanism and lifting or lowering the patient. FIG. 5 shows a power drill, detachably mated to coupling 58, being used to actuate the lifting mechanism.

It will be appreciated that the use of a power tool to actuate the lifting mechanism via the coupling 58 has a number of advantages. One advantage is that the lifting and lowering of the patient can be done without the user having to exert much physical effort. Without the power tool, the lifting and lowering of the patient would typically be done by the movement of chain 24. A user may have to lift and lower a patient many times each day. It is also possible that the user will himself be lacking in physical strength, and will have trouble repeatedly lifting and lowering a patient by manually actuating the lifting mechanism. For these and other reasons, the reduction in physical effort needed to lift and lower the patient is advantageous.

Another advantage is that this invention provides powered lifting and lowering without the lift itself being motorized. Thus, the lift can be much lighter than it would have been if a motor were included. This is particularly advantageous for portable lifts carried from place to place.

Furthermore, in motorized lifts, if the motor fails, there is downtime while the motor is repaired. However, in this invention, if the power tool fails, the chain can be used while the power tool is repaired or replaced. In addition, widely available power tools, such as drills, powered screw drivers and powered ratchet wrenches can typically be replaced fairly easily and cheaply, much more so than a motor in a motorized patient lift device.

In the result, the preferred embodiment allows a user to enjoy one or more advantages of a motorized lift, while avoiding one or more disadvantages of a motorized lift.

Preferably, the lift device 10 also includes a brake 60, preferably positioned within the worm gear 48. In a preferred form, a one-way clutch bearing 62 is provided upon which is mounted a cone shaped brake element 64. A conical braking or slip surface 66 is formed in the end of the worm gear 48, which is sized and shaped to match with the conical surface 68 of the cone shaped brake element 64. A ball-bearing 70 is also mounted onto the same axle as the cone shaped brake element 64.

The operation of the braking assembly 60 can now be understood. By means of the ball-bearing element the cone shaped brake element can be rotated in direction of arrow 72 together with the worm gear. Thus, when winding the strap to raise the patient, the worm gear and brake element rotate together, by means of the ball-bearing. However, in the lowering direction, the ball-bearing is not rotatable, meaning that for there to be any rotation the rotation must occur between the cone shaped brake surface 68 and the slip surface 66 of the worm gear 26. The cone shaped brake surface 68 will have a braking force that is a function of the seating force, namely how strongly the worm gear is pushed onto the brake surface 68. The seating force is proportional to the weight being carried by the lift device. That weight creates a force against the spool, which in turn causes the spool gear's teeth to exert the seating force. In the preferred embodiment, the seating force acts along the axis of the cylinder of worm gear 48. The greater the suspended weight, the greater the seating force and the greater the braking force. Thus, through this interacting structure a braking force can be generated which is larger for larger weights. Thus in the design range of lifting weights for the device, the braking force is self-compensating to be strong enough to support all patients, and yet for lighter patients will be less than for heavier patients.

The operation of the brake 60 can now be understood. When a load is to be lifted, the load is attached to the lift device and lifting commences. Because the drive train of the present invention is quite efficient, most of the effort in lifting actually is directed to raising the weight, rather than to overcoming the frictional losses arising from the drive train. As noted, because the brake is mounted on a ball-bearing mechanism, none of the lifting effort is directed to overcoming the braking force.

On the other hand, when lowering is required the motor reverses direction and the motor has to generate enough power to overcome the difference between the braking force generated by the brake and the weight. Since the weight is already in the lowering direction, only the difference between the weight and the braking force must be overcome to initiate motion. In this way, while a significant factor of safety can be built into the braking force, such that, for example, the braking force generated will always be between 1.5 and 2 times the weight, the user will only have to generate enough force to overcome the difference between the two. This is particularly useful when the user is using chain 24 to manually actuate the lift device 10.

It is also preferred that the unmotorized lifting mechanism, including in particular the worm gear 48, be efficient enough so as to be non-self-braking i.e. that they would backdrive unless force is applied to prevent it. As explained above, such efficiency is helpful for reducing the amount of energy needed to use the lift.

It will be appreciated by those skilled in the art that various modifications and alterations to the invention are possible without departing from the broad spirit of the invention as described above and in the appended claims. Some of these were discussed above and others will be apparent. For example, the unmotorized lifting mechanism, while preferably including gears as described, may take other forms and still be comprehended by the invention. What is important is that the unmotorized lifting mechanism function to lift a patient while being unmotorized. The power tool coupling may be configured to actuate the lifting mechanism by rotary motion, as is preferred, but other types of actuation are comprehended by the invention. The lift preferably includes a manual actuator, but the invention comprehends the absence of a manual actuator.

The embodiments of the invention in which an exclusive property or privilege is claimed are defined as follows:

1. A patient lift device comprising:
a patient carrier for carrying a patient to be lifted;
a support element sized, shaped and positioned to couple the patient lift device to an upper support;
an unmotorized lifting mechanism, operatively connected to the patient carrier and support element so as to raise or lower the patient carrier when the unmotorized lifting mechanism is actuated;
a power tool coupling, operatively connected to the unmotorized lifting mechanism such that when a power tool is coupled to the power tool coupling and actuated, the unmotorized lifting mechanism is actuated, the power tool coupling being configured to detachably mate with a driven power tool head.

2. A patient lift device as claimed in claim 1, the patient lift device further comprising a manual actuator configured and positioned to actuate the unmotorized lifting mechanism.

3. A patient lift device as claimed in claim 2, wherein the manual actuator comprises a chain.

4. A patient lift device as claimed in claim 3, wherein the unmotorized lifting mechanism includes a sprocket having teeth configured to be gripped by the chain.

5. A patient lift device as claimed in claim 4, wherein the chain comprises a plurality of joined links, each link including a hole sized, shaped and positioned to grip said teeth.

6. A patient lift device as claimed in claim 5, wherein each said link comprises a shaft and a recess, the shaft of each link being sized, shaped and positioned to snap fit into a recess of an adjacent link to form a chain.

7. A patient lift device as claimed in claim 5, wherein said links are substantially identical to one another in shape.

8. A patient lift device as claimed in claim 1, wherein said patient carrier comprises a pair of hooks, said hooks being sized, shaped and positioned to hold a patient harness.

9. A patient lift device as claimed in claim 8, wherein each hook includes a movable arm having an open position for admitting the patient harness and a closed position for holding the patient harness on the hook.

10. A patient lift device as claimed in claim 9, wherein the movable arm is biased to the closed position.

11. A patient lift device as claimed in claim 1, wherein the support element comprises a strap connected to the unmotorized lifting mechanism, and an attachment element sized, shaped and positioned to connect the strap to the upper support.

12. A patient lift device as claimed in claim 11, wherein the unmotorized lifting mechanism comprises a spool for winding and unwinding said strap, and a mechanism for moving said spool so as to wind and unwind said strap.

13. A patient lift device as claimed in claim 12, wherein said mechanism for moving said spool comprises a plurality of gears.

14. A patient lift device as claimed in claim 1, wherein said power tool coupling comprises a female coupling configured to detachably mate with a male driven power tool head.

15. A patient lift device as claimed in claim 14, wherein the power tool coupling comprises a recess for receiving a Robertson screwdriver head.

16. A patient lift device as claimed in claim 14, wherein the power tool coupling comprises a hexagonal recess.

17. A patient lift device as claimed in claim 14, wherein the coupling comprises a substantially cube-shaped recess.

18. A method of lifting a patient that is attached to a patient lift device, the patient lift device including an unmotorized lifting mechanism, the method comprising the steps of:
mating the driven power tool head of a power tool with a power tool coupling on the patient lift device;
actuating the power tool to drive the power tool head so as to actuate the power tool coupling and the unmotorized lifting mechanism;
detaching the driven power tool head from the power tool coupling.

19. The method as claimed in claim 18, wherein the power tool comprises a power drill.

20. The method as claimed in claim 18, wherein the power tool comprises a powered screw driver.

21. The method as claimed in claim 18, wherein the power tool comprises a powered ratchet.
